(19) United States
(12) Patent Application Publication
(10) Pub. No.: US 2015/0101244 A1
(43) Pub. Date: Apr. 16, 2015

(54) METHOD FOR HYDRATING CUT FLOWERS AND AN ABSORBENT PAD FOR USE THEREWITH

(71) Applicant: Paper-Pak Industries, Laverne, CA (US)

(72) Inventor: Sayandro Versteylen, Fontana, CA (US)

(21) Appl. No.: 14/516,094

(22) Filed: Oct. 16, 2014

Related U.S. Application Data
(60) Provisional application No. 61/891,780, filed on Oct. 16, 2013.

(51) Int. Cl. A01G 27/04; A01G 1/00; A01N 27/00; A01G 9/02

(52) U.S. Cl. CPC A01G 27/04; A01G 9/02; A01G 1/001; A01N 27/00
USPC 47/41.01; 47/58.1 CF; 428/212; 504/114

(57) ABSTRACT

A method for hydrating cut flowers during packing, storage, and transport is provided. The present disclosure also provides a method for hydrating cut flowers in which a particular absorbent pad is used therein. The present disclosure further provides that the absorbent pad can contain an active agent that is activated by water to nourish and treat the cut flowers and/or inhibit growth of microorganisms.

### CROSS-REFERENCE TO RELATED APPLICATIONS

The present application claims priority of U.S. Provisional Patent Application Ser. No. 61/891,780, filed on Oct. 16, 2013, the contents of which are hereby incorporated by reference in their entirety.

### BACKGROUND OF THE DISCLOSURE

1. Field of Disclosure

The present disclosure provides a method for hydrating cut flowers. More particularly, the present disclosure provides a method for hydrating cut flowers in which an absorbent pad is used.

2. Description of Related Art

Cut flowers are transported from flower growers around the world, frequently in South America, Europe, and Africa, to distribution centers in the U.S., Europe, and Asia. The cut flowers are further transported to florists or retail locations where they are sold to consumers. More than 65% of the cut flowers consumed in the United States at present are grown in Andean countries. Colombia is the largest producer followed by Ecuador, which produces primarily roses, and then by Peru. African countries, such as Kenya, are also major producers of cut flowers, with the primary outlet to Europe through the Netherlands. Two of the primary transit and distribution centers for cut flowers are Miami, Fla. (United States) and Amsterdam (Netherlands).

However, because of the great distances between flower growers and the distribution centers, and then to consumers, cut flowers can become dehydrated during packaging, storage, and transport.

One conventional method to reduce dehydration during transport of cut flowers is to ship the flowers with their stems partly submerged in a container of water. This has the disadvantage that a significant portion of shipping weight is dedicated to shipping water (and the container). Also, the water has a tendency to spill outside of the container, which is typically not tightly closed. Also, water can be a growth medium for microorganisms that also can cause deterioration of cut flowers during transport, particularly if nutrients and plant food are added.

The cut flower market is intensely focused on the quality of the flower. A poor-quality flower generally cannot be sold no matter how inexpensively the flower is priced.

The general process for transporting cut flowers is as follows: harvesting flowers from the ground by cutting; taking the cut flowers to a collecting center and processing the same for transport; treating the cut flowers by dipping their stems in a solution that kills insects and other pests, which is required for importing cut flowers into the United States and Europe; cleaning, drying, and bundling the cut flowers; and placing the cut flowers in a shipping container for transport.

The shipping containers of cut flowers are then chilled in a refrigerator to a temperature of approximately 34° F.-40° F. (1.1° C.-4.4° C.), which decreases the rate of respiration of the cut flowers. The refrigerated shipping containers of cut flowers are then loaded on refrigerated trucks, and transported to an airport. The refrigerated shipping containers are loaded into the cargo hold of an airplane or ship, and transported to a floral transit center, such as Miami (Fla.), United States, or Amsterdam, Netherlands. Upon arrival in the floral transit center, the refrigerated shipping containers of cut flowers are moved from the cargo hold to a refrigerated warehouse. The refrigerated shipping containers of cut flowers are loaded onto refrigerated trucks or other delivery vehicles for transporting to florists, retail stores (e.g., supermarket or convenience store), or to local warehouses for shipping to another retail location. Upon reaching the final retail destination, the cut flowers are removed from the refrigerated shipping container and placed in refrigerated display cases or on a retail floor for sale to consumers, who take the cut flowers home to display in a vase at room temperature. The cut flowers deteriorate rapidly after removal from a chilled environment.

The cut flowers typically remain in the shipping container for about 5 to 7 days if shipped to a flower transit center in the U.S. but often longer if shipped to a transit center in Europe, which adds even more time in the shipping container before the cut flowers arrive at their destinations where they are distributed for sale to consumers. If the cut flowers are left at the floral transit center for even an extra day or two before final trans-shipping, there are considerable losses of flowers that must be thrown away as unsellable.

Hydration of cut flowers during this process will enhance the quality and appearance when the flowers arrive at the distribution centers or are delivered to a florist or consumer. However, conventional approaches to provide hydration to cut flowers during transport, such as those described above, are costly (by adding to shipping weight) and inefficient.

### SUMMARY OF THE DISCLOSURE

The present disclosure provides a method for hydrating cut flowers.

The present disclosure also provides such a method for hydrating cut flowers in which a particular absorbent pad is used therein.

The present disclosure further provides that the absorbent pad used in the method has layers of tissue and a layer of superabsorbent material that provide controlled delivery of water to hydrate cut flowers during packing, storage and transport.

The present disclosure still further provides that the absorbent pad can also contain an active agent that is activated by water to nourish and treat the flower, and/or inhibit growth of microorganisms that would otherwise cause deterioration of the cut flower.

The present disclosure yet further provides that the absorbent pad has an absorbent body that can have one or more tissue layers that enhance wicking and migration of water through the absorbent pad both horizontally across the plane of the each tissue layer and vertically among several adjacent tissue layers.

The present disclosure also provides that the absorbent pad can have a layer of superabsorbent material as a water reservoir that pulls in water from the tissue layers and then gradually relinquishes water to the tissue layers, where the water is available to hydrate the cut flower during storage and transport.

### BRIEF DESCRIPTION OF THE DRAWINGS

FIG. 1 is a perspective view of an exemplary embodiment of an absorbent pad of the present disclosure.

FIG. 2a is a cross-section of the exemplary embodiment of the absorbent pad in FIG. 1 taken along axis A-A through the absorbent pad.

FIG. 2b is a cross-section of another exemplary embodiment of the absorbent pad in FIG. 1 taken along axis A-A through the absorbent pad.

FIG. 3 is another illustration showing the relation of the tissue layers and superabsorbent layer in another exemplary embodiment of the absorbent pad.

FIG. 4 is a first step of the method of the present disclosure.

FIG. 5 is a second step of the method of the present disclosure.

FIG. 6 is a third step of the method of the present disclosure.

FIG. 7 is a representative embodiment of transporting cut flowers that are hydrated by the method of the present disclosure.

### DETAILED DESCRIPTION OF THE DISCLOSURE

The present disclosure provides a method for hydrating cut flowers. In particular, the method can employ an absorbent pad to hydrate cut flowers during packing, storage, and transport.

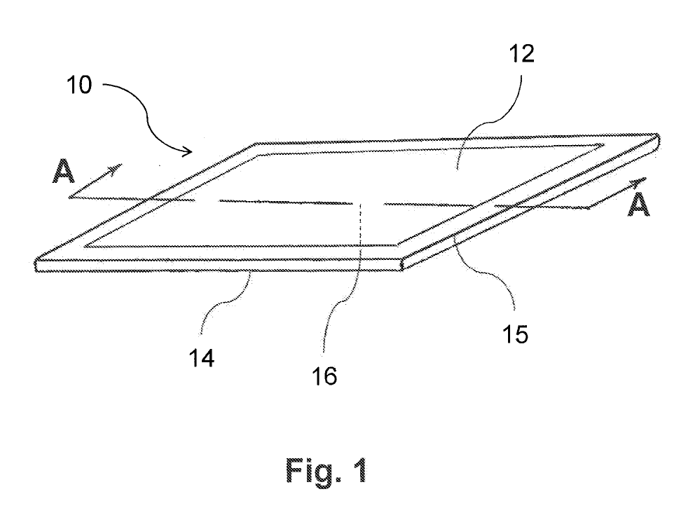

Referring to the drawings, and in particular, to FIGS. 1, 2a, 2b, and 3, there is provided an exemplary embodiment of an absorbent pad generally represented by reference number 10 that can be used in the method for hydrating cut flowers.

Absorbent pad 10 has a top layer 12, and a bottom layer 14 opposite top layer 12. Between top layer 12 and bottom layer 14 is an absorbent body 16 made of one or more layers of an absorbent and/or superabsorbent material. Top layer 12 and bottom layer 14 directly contact each other and are sealed at edges 15 to seal absorbent pad 10 and enclose absorbent body 16. If part of absorbent pad 10, superabsorbent layer 19 is positioned between top layer 12 and bottom layer 14.

In an alternative embodiment, absorbent pad 10 can have one or more of edges 15 that are left unsealed to form an open cell pad.

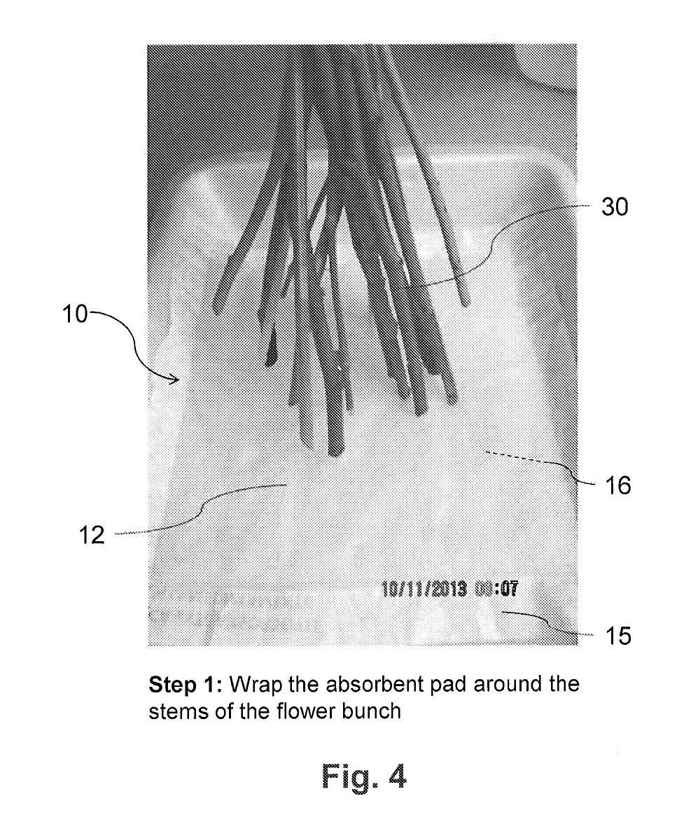

In the method of the present disclosure, top layer 12 is positioned to be in contact with the stems 30 of the cut flowers 32 as shown in FIG. 4-6. Top layer 12 is a liquid-permeable material. In a preferred exemplary embodiment, top layer 12 is a nonwoven material. Examples of nonwoven materials for top layer 12 include, but are not limited to, polyolefin, polyester, and polyamide. Preferably, the nonwoven is polyethylene, polypropylene, polyester, or any combination thereof. In a preferred exemplary embodiment, top layer 12 is made of spunbonded polypropylene. Top layer 12 can also be a hydrophilic nonwoven material, or treated with a surfactant or other hydrophilic material, to permit uptake and absorption of water into absorbent body 16. Alternatively, top layer 12 can be made of coffee filter tissue (CFT). The CFT can be a 16.5-pound white crepe paper that is about 99.5% softwood pulp, where “softwood pulp” means a pure virgin wood pulp that has never been processed. The softwood pulp can be bleached or unbleached. CFT can also contain about 0.5% of a wet-strength resin to give strength to the cellulosic fibers of the CFT when wet. An example of a wet-strength resin includes, but is not limited to, polyamide-epichlorohydrin (PAE) resin film that is polyethylene, polypropylene, polyester, or any combination thereof.

Bottom layer 14 is generally positioned to be farthest from the stems 30 of cut flowers 32. Bottom layer 14 is preferably a liquid-impermeable material. In an exemplary embodiment, bottom layer 14 is a film that is polyethylene, polypropylene, polyester, or any combinations thereof. In a preferred exemplary embodiment, bottom layer 14 is a blown polyethylene film. The blown polyethylene film can have a thickness of about 0.65 mil. In another embodiment, bottom layer 14 is a nonwoven that is a hydrophobic material that is partly or entirely impermeable to water. In still another exemplary embodiment, bottom layer 14 is made of coffee filter tissue (CFT).

As noted above, in a preferred embodiment, absorbent pad 10 is sealed around its periphery at edges 15. The sealed portion is about a half-inch (0.5″) (1.3 cm) around each edge 15. However, the amount of edge 15 that is sealed can vary in size to be more or less than 0.5″.

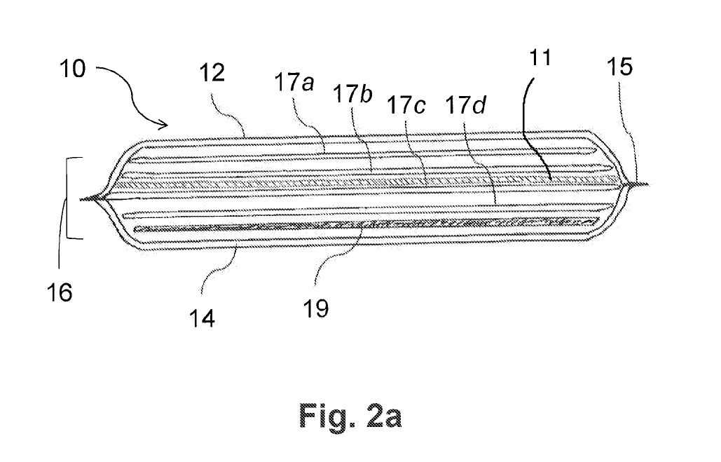

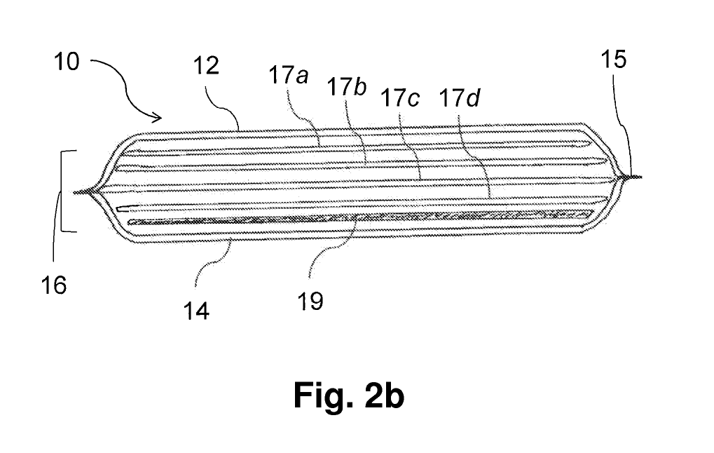

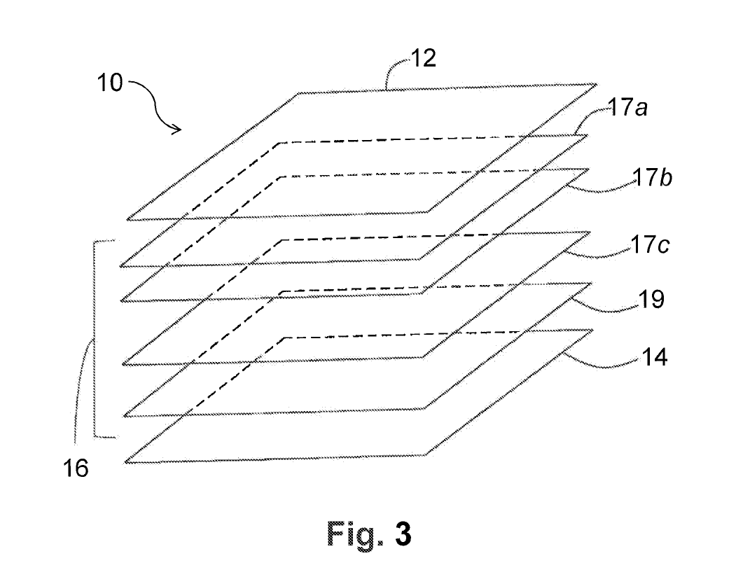

Absorbent body 16 is made of one or more layers of an absorbent material, and can be made of a superabsorbent material. Absorbent body 16 absorbs liquids that contact absorbent pad 10, and/or condensation that forms in the container for the flowers or the atmosphere while cooling the cut flowers 32 during storage or transport. Absorbent body 16 is preferably made of an absorbent material that is one or more layers of tissue 17 (tissue 17 means either one or all layers of tissue, each separate layer being shown in FIGS. 2a and 2b as 17a to 17d, and in FIG. 3 as 17a to 17c). Each tissue layer 17 is a sheet of cellulose tissue, and can itself be formed of one or more individual tissues that are joined together to form the tissue layer. In a preferred embodiment, one or more of tissue layers 17 is a layer of crepe tissue. The number of tissue layers 17, as well their arrangement in the pad architecture of absorbent pad 10, can vary to regulate the absorption for the absorbent pad, as well as to regulate activation of any active agents therein. Besides tissue, the absorbent material can also be fluff pulp, cellulosic material, binding fiber, airlaid, nonwoven, woven, polymer, absorbent gels, compressed composite with short or microfiber materials, thermoplastic polymer fibers, cellulose powders, or any combinations thereof.

Referring to FIGS. 2a and 2b, the exemplary embodiment of absorbent pad 10 has top layer 12 that is a nonwoven, and bottom layer 14 that is a polyethylene film. In the embodiment in FIGS. 2a and 2b, absorbent body 16 has four tissue layers 17a to 17d, where all four tissue layers are disposed above superabsorbent layer 19. One tissue layer 17a is adjacent to top layer 12, and another tissue layer 17d is adjacent to superabsorbent layer 19.

FIG. 3 is an illustration of another exemplary embodiment of absorbent pad 10, showing top layer 12, bottom layer 14, and edges 15 around the periphery of absorbent pad 10 where top layer 12 and bottom layer 14 are joined and sealed to enclose absorbent body 16. In this embodiment, absorbent body 16 has three tissue layers 17a to 17c disposed above superabsorbent layer 19.

Tissue layers 17 have the ability to wick water and moisture horizontally and vertically through absorbent pad 10, and thereby enhance migration of water throughout the entire absorbent pad. As the water and/or moisture is distributed horizontally along the plane of an individual tissue layer (for example, along the horizontal plane of tissue layer 17c), the active agents on that particular tissue layer are activated. Vertical migration of water and moisture also can carry one active component to react with another active agent that is positioned on a different level of the pad architecture. In this way, the rate and duration of activity of the active agent can be controlled and prolonged by selecting the type and thickness of each layer to control vertical migration, by the stoichiometry and amount of the active agents, and by placement of active agents in different portions of absorbent pad 10.

Tissue layers 17 further provide the advantage of uniform distribution of absorbed water or other liquids throughout absorbent pad 10, end-to-end. For example, tissue layer 17a made of cellulose has cross-linked fibers that distribute absorbed water horizontally across the plane of tissue layer 17, fiber-to-fiber, from one end of absorbent body 16 to its opposite end, as well as widthwise from one edge to its opposite edge. In addition, where a second tissue layer 17b and a third tissue layer 17c are adjacent to first tissue layer 17a, any absorbed water will also distribute vertically, from fiber-to-fiber, from the tissue fibers in the first tissue layer 17a to second tissue layer 17b, and thence to third tissue layer 17c, and so on, including to superabsorbent layer 19. If sufficient water is absorbed, this horizontal and vertical distribution allows absorbent pad 10 to be uniformly “wetted” with absorbed water that is then available to hydrate the cut flower and to activate one or more active agent in the pad architecture. Thus, tissue layers 17 provide that absorbed water is distributed three-dimensionally in absorbent pad 10. This is an advantage over fluff absorbent material, which can form into “clumps” of fluff having spaces therebetween, which cannot distribute water or moisture uniformly across absorbent pad 10 because of spaces where there is little or no fluff material. An exemplary embodiment of absorbent pad 10 having one or more tissue layers 17 is 15% lighter, yet 17% more absorbent, than a comparably-sized pad that has fluff material for absorbency.

Referring to FIG. 2a, absorbent pad 10 can also include a laminate 11 positioned between top layer 12 and bottom layer 14. When present, laminate 11 is preferably a part of absorbent body 16, along with tissue layers 17 and/or other absorbent material. Alternatively, the laminate 11 can be the entire absorbent body 16. Laminate 11 can be made of one or more plies of a cellulosic material, an adhesive (such as glue) or binder, and preferably includes an active agent. In an exemplary embodiment, a laminate that is 3.0 grams per square inch (GSI) in an absorbent body that is 3 inches by 5 inches can provide about 45 grams of absorbency to absorbent pad 10.

Superabsorbent layer 19 is a thin superabsorbent material that can absorb and retain water. Examples of a superabsorbent material include, but are not limited to, polyacrylate or carboxymethyl starch (CMS), superabsorbent polymer (SAP), compressed SAP, composite of SAP granules adhered with binder or plasticizer, airlaid with SAP, or a starch-based superabsorbent material, such as BioSAP™ (Archer-Daniels Midland, Decatur, Ill.), which is biodegradable, compostable, and a renewable resource.

In the embodiment of FIGS. 2a and 2b, superabsorbent layer 19 is positioned below all four tissue layers 17a to 17d. Similarly, in the embodiment of FIG. 3, superabsorbent layer 19 is positioned below three tissue layers 17a to 17c. An advantage to positioning superabsorbent layer 19 near to, or even adjacent to, water-impermeable bottom layer 14 protects the water absorbed in superabsorbent layer 19 from direct contact with stems 30, and allows superabsorbent layer 19 to be a water reservoir that holds the water so the water does not flow away, yet is sufficiently wet to hydrate the cut flowers in the present method. As tissue layer 17a gradually relinquishes its water to stems 30 through top layer 12, tissue layer 17a then pulls water from adjacent tissue layer 17b, which, in turn, pulls water from adjacent tissue layer 17c, and so on, up to the water reservoir stored in superabsorbent layer 19, providing a “one-way” hydrating flow, and a controlled release of water to the cut flowers.

In another preferred embodiment not shown, superabsorbent layer 19 is positioned between two tissue layers 17 in the middle portion of absorbent body 16.

The absorbency of the absorbent material and/or superabsorbent material and/or superabsorbent layer 19 in absorbent body 16 is typically from about 10 grams to about 1000 grams for absorbent pad 10 having outer dimensions of about five (5) inches by about five (5) inches, where “absorbency” means the weight of liquid that can be absorbed by absorbent pad 10. More preferably, the total absorbency of absorbent pad 10 is from about 250 grams to about 600 grams. Still more preferably, the total absorbency of absorbent pad 10 is from about 400 grams to about 600 grams, with an average absorbency of about 500 grams.

Absorbent pad 10 can be characterized by its “water delivery capacity,” which is how much water that can be stored in absorbent body 16, and how much water is available for the cut flowers.

As described above, absorbent body 16 is preferably slightly smaller than the overall outer dimensions of absorbent pad 10, so that top layer 12 and bottom layer 14 can be more easily sealed around edges 15. In an exemplary embodiment, absorbent body 16 is about five inches (5″) (12.7 cm) in length by about two and a half inches (2.5″) (6.4 cm) in width, in absorbent pad 10 having overall outer dimensions of six inches (6″) (15.2 cm) in length by about three and a half inches (3.5″) (8.9 cm) in width, thereby leaving about 0.5 inches (0.5″) (1.3 cm) perimeter around all four edges 15 of absorbent pad 10 for sealing. Absorbent pad 10 can have outer dimensions and be of a shape that accommodates the shapes and footprint of any box or container in which flowers might be transported.

In a preferred embodiment, absorbent pad 10 has an active agent that is an antimicrobial agent (or a mixture of antimicrobial agents) that prevents degradation of the flower by microorganisms, such as fungi that cause botrytis. The active agent is preferably disposed in absorbent body 16.

An example of an antimicrobial agent in absorbent pad 10 is citric acid. However, any antimicrobial can be employed, including, but not limited to, organic acids (that include, but are not limited to, citric acid, sorbic acid, lactic acid, ascorbic acid, oxalic acid, tartaric acid, acetic acid, and any combinations thereof), inorganic acids (such as boric acid), quaternary ammonium compounds, and any combinations of such antimicrobials. Boric acid (and its salts, such as sodium borate) is a preferred active agent because of its bacteriostatic and antimicrobial activity, its buffering capacity, and its long use as an antimicrobial preservative in cosmetic products and pharmaceuticals. Also, boric acid does not readily penetrate intact skin, and so is relatively safe to handle with normal precautions, such as gloves, protective clothing, and eye protection.

In another exemplary embodiment, the antimicrobial agent can be an atmosphere modification system, including, but not limited to: CO₂-generating system, O₂-scavenging system, chlorine dioxide (ClO₂), botrytis-inhibiting agent such as sulfur dioxide (SO₂), ethylene scavenging system, and any combinations thereof.

The total amounts of the antimicrobial agent can be advantageously scaled to the total absorbency of absorbent pad 10. For example, an embodiment of absorbent pad 10 with absorbent body 16 (i.e., absorbent tissue layers 17 and superabsorbent layer 19) that can absorb about 50 grams of water can contain about 1.0 gram of citric acid, which is about 2.0 weight % (wt %), based on the nominal absorbency of the absorbent pad, for consistent inhibition of bacterial growth. For a different embodiment having a nominal absorbency of about 40 grams, the amount of the antimicrobial in absorbent body 16 is about 0.83 grams total, which is about 2.1 wt %, based on the nominal absorbency of the absorbent pad.

An exemplary embodiment of a CO₂ generation system is an acid and a base, such as citric acid and sodium bicarbonate, respectively, that react with each other (when activated by water or other liquid) to generate CO₂ gas. The acid component of the CO₂ generation system can be an organic acid (that includes, but is not limited to, citric acid, sorbic acid, lactic acid, ascorbic acid, oxalic acid, tartaric acid, acetic acid, and any combinations thereof) and inorganic acids (such as boric acid). The ratio and amounts of acid and base, as well as their physical placement in the pad architecture, can be varied to control the timing and amount of CO₂ released. In one exemplary embodiment, citric acid and sodium bicarbonate are present in absorbent body 16 in a ratio of about 4:6, which can be activated by moisture and/or other water to generate CO₂ gas. Citric acid provides an additional benefit by interacting with the sodium ion of sodium bicarbonate to create a citric acid/sodium citrate buffer system that helps maintain a pH that is compatible with preservation of flowers. Sodium citrate salt can also reduce water retention by superabsorbent layer 19, thereby releasing additional water from the superabsorbent layer into tissue layers 17 to be available to hydrate the cut flowers. Other acids can be selected for a CO₂ generation system, with amounts and ratios adjusted in accordance with the pKₐ of the acid.

Examples of an ethylene inhibitor or ethylene competitor agents include, but are not limited to, 1-methylcyclopropene, (also called “MCP” or “1-MCP”), its salts and chemical derivatives. Another example of an ethylene inhibitor is a strong oxidizing agent, such as potassium permanganate (KMnO₄), which chemically reacts with ethylene to reduce the amount of free ethylene available to bind to ethylene receptors of the cut flowers. The one or more ethylene competitor agents can be selected to bind either reversibly or irreversibly to the ethylene receptors in the cut flowers.

Examples of an oxygen scavenging system is any enzyme that includes, but is not limited to, glucose oxidase, catalase, lactase, oxidoreductase, invertase, amylase, maltase, dehydrogenase, hexose oxidase, oxygenase, peroxidase, cellulase, and any combinations thereof. Other examples of an oxygen scavenging system include an oxidizable metal, including, but not limited to, iron, zinc, copper, aluminum, tin, and any combinations thereof.

As noted above, another example of an antimicrobial agent that can prolong the life of cut flowers is chlorine dioxide (ClO₂), which can be generated in the shipping container by one or more ClO₂-generating components. The shipping container for the cut flowers can have a liner of coated paper having a chlorine dioxide (ClO₂)-generating system coated thereon that is positioned on one or more of the container surfaces. Alternatively, the ClO₂-generating components can be present inside of absorbent pad 10. Chlorine dioxide is an antimicrobial that reduces the effects of fungi (such as fungi that cause botrytis and its associated damage in cut flowers), and demonstrably changes the atmosphere in the shipping container. However, the ClO₂-generating system needs to be kept physically separated from water until activation since it is water-activated. Also, concentrations of the components of the ClO₂-generating system have to be carefully regulated to prevent discoloration of the cut flowers. Thus, it is important that the concentrations of the components of the ClO₂-generating system are carefully regulated to prevent discoloration of the cut flowers.

An exemplary embodiment of an SO₂ generation system includes, but is not limited to, sodium metabisulfite (Na₂S₂O₅), which reacts with water and/or moisture to generate SO₂.

Still other active agents that can be used in absorbent pad 10 include vitamins, sugar (as a source of carbohydrates), plant hormones, and other plant “foods” that nourish or treat the cut flower. For example, an embodiment of absorbent pad 10 includes a sugar that is sucrose and/or glucose. Another embodiment of absorbent pad 10 includes a plant hormone that is a cytokinin.

By pre-selecting the amount of an active agent, such as a vitamin, nutrient, or plant food in absorbent pad 10, the grower, florist, or consumer only has to add water to the absorbent pad, and the “right” amount of the treatment is provided to the cut flowers.

Each active agent/active system can be positioned in a pocket in absorbent pad 10 that is formed by: any two tissue layers 17; any tissue layer 17 and superabsorbent layer 19; topmost tissue layer 17 and top layer 12; and/or bottommost tissue layer 17 and bottom layer 14. Alternatively, an active agent can be incorporated in or on superabsorbent layer 19.

As used in this application, the “pad architecture” of absorbent pad 10 means the structure and order of individual tissue layer(s) 17, superabsorbent layer 19, the top and bottom layers 12 and 14, respectively, or any active agents therein. “Regulation” means controlling the speed, location, and amount of liquid absorption, as well as controlling activation speed and duration of release of active agents. Thus, varying the pad architecture can be used to regulate uptake of liquids exuded by a flower on absorbent pad 10, and regulate activation, rate of release, and duration of the active agent. A pad architecture that physically separates the individual chemical components of an active agent with tissue layers can be selected to delay activation and/or provide an “extended release” of the active agent contained in absorbent pad 10. For example, positioning a larger number of tissue layers 17 above and/or below superabsorbent layer 19 can delay activation and extend release of an active agent in superabsorbent layer 19. In an exemplary embodiment shown in FIGS. 2a and 2b, positioning four tissue layers 17a, 17b, 17c, 17d above superabsorbent layer 19 can delay activation, and also serve as a reservoir for extended release or extended availability of water.

As used in this application, “scaling,” means selecting the proper amounts of active agent in relation to the amount of absorbent material and the type of flower being packaged. Scaling is critical to the performance of absorbent pad 10. Some flowers produce very little moisture or water that would be available to activate the active agent, while other flowers produce a large amount of moisture or water. For example, if absorbent pad 10 has too many tissue layers 17 relative to the amount of absorbed water, there may be insufficient liquid to dissolve the active agent(s) for their activation. Conversely, too few tissue layers 17, combined with a large volume of absorbed water, can dilute or even “drown” the active agent, thereby impairing its effectiveness.

The amount of active agent in the pad architecture of absorbent pad 10 of the present disclosure for a given container of flowers can also be tailored depending on several factors, including, but not limited to: the total volume of the container; the amount of flowers in the container (i.e., how much volume the flowers occupy); how much of the active agent is expected to be lost; and other physical factors, such as temperature and pressure. Likewise, as noted above, the pad architecture can be tailored to regulate the rate of release of the active agent. For example, using a pad architecture where portions of the active agent are physically separated can provide a sustained release of an active agent (such as an antimicrobial) to provide maximum capacity of the active agent in the container.

The pad architecture of absorbent pad 10 has the benefit that absorbent body 16 (e.g., tissue layers 17) actively “draws in” the water, where it is retained in the tissue layers and superabsorbent layer 19, and then gradually released over time to hydrate the flowers. The drawing action of absorbent pad 10 increases the extent by which the pad retains, and then gradually releases, the water to the flowers.

FIGS. 4 through 6 illustrate an exemplary embodiment of the method of the present disclosure.

Referring to FIG. 4, the first step of the method of the present disclosure is shown. In this first step, absorbent pad 10 is positioned around stems 30 of flowers 32 so that top layer 12 is in contact with the entire circumference and bottom of stems 30.

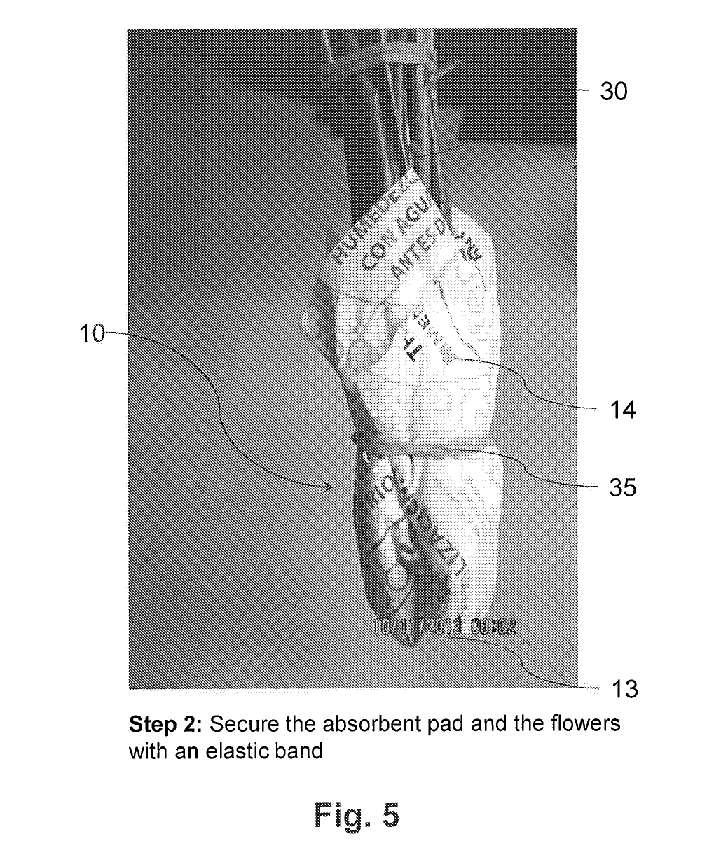

The second step is shown in FIG. 5. In this step, absorbent pad 10 is secured to flowers 32 around stems 30. Preferably, the securing is by an elastic band 35. However, any other device for securing can be used provided that it does not obstruct the direct contact of top layer 12 with stems 30. Absorbent pad 10 forms a bowl-like shape so that the bottom of stems 30 are entirely enclosed in absorbent pad 10, with the absorbent pad 10 forming a bottom 13 for holding water and moisture.

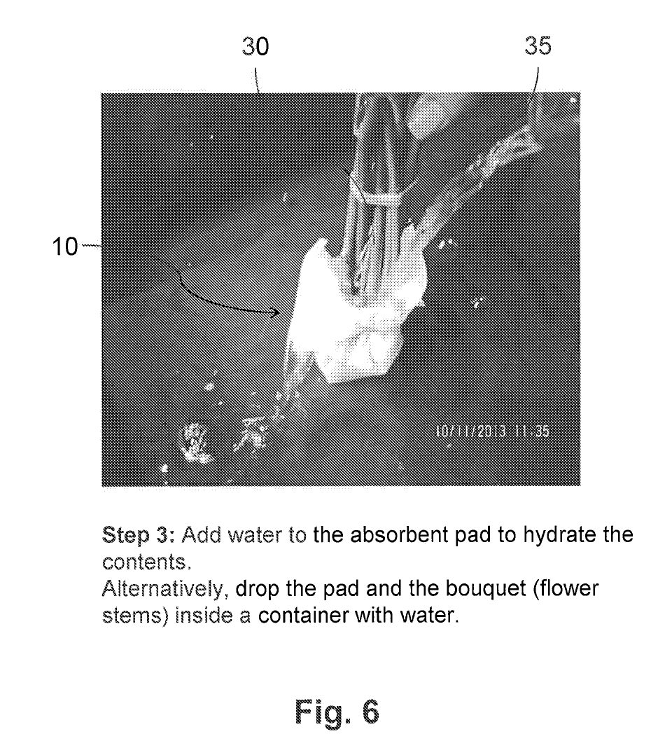

Referring to FIG. 6, in which the third step of the present method is shown, water 35 is added to absorbent pad 10 to hydrate the absorbent pad and stems 30 in contact therewith. Alternatively, absorbent pad 10 and stems 30 can be dunked into a basin of water to soak absorbent pad 10, after which the absorbent pad and flowers are lifted out of the water.

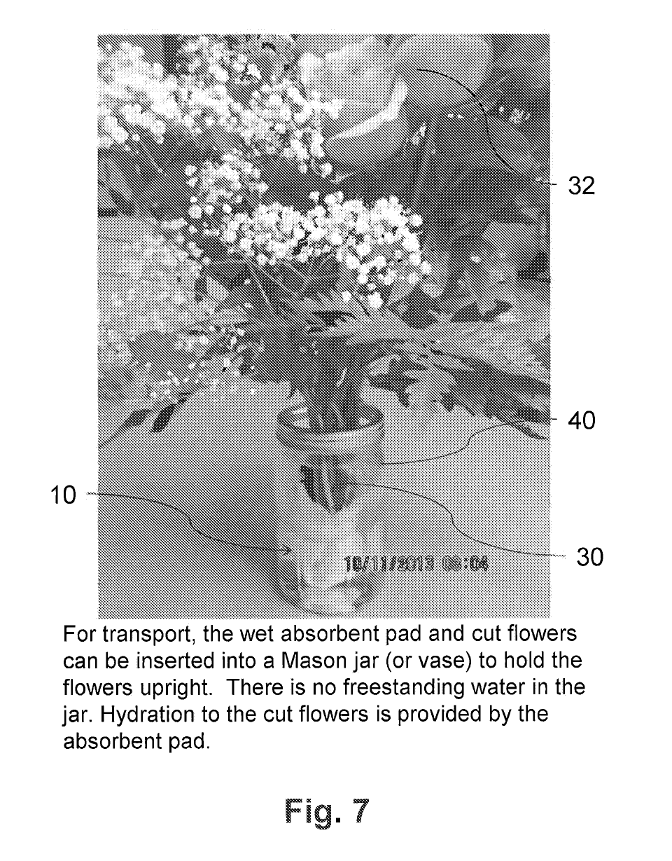

FIG. 7 shows a representative way of transporting cut flowers that are hydrated by the method of the present disclosure. The secured absorbent pad 10 and stems 30 are inserted into an empty jar, vase or container 40 (such as the Mason jar shown in FIG. 7) to hold the cut flowers in a vertical orientation during transport. There is no freestanding water in container 40. All hydration to stems 30 is supplied by the water contained in absorbent pad 10. Thus, the present method hydrates the cut flowers while avoiding the microbial growth that can occur in freestanding water. The present method also has the benefit of eliminating water spillage and reducing evaporation losses that occur when cut flowers are shipped with stems immersed in a container of water. In addition, the present method significantly reduces overall shipping weight (eliminating the extra weight of shipping containers of freestanding water) when transporting cut flowers, and consequently reduces fuel and shipping costs.

Alternatively, the secured absorbent pad 10 and stems 30 of cut flowers 32 prepared by the method illustrated in FIGS. 4-6, can be placed in any box or shipping container or pallet. The cut flowers can be oriented horizontally or vertically, and can be shipped in any manner including in a box or shipping container, since the stems 30 continue to be hydrated solely by the secured absorbent pad 10. Multiple groups of cut flowers can be transported in the same box to achieve greater cost-efficiency.

Yet a further alternative is to use the method of the present disclosure in a display of groups of flowers at a florist shop or retail store (and/or storage thereof in the florist shop or retail store), where the secured absorbent pad 10 for a single group of flowers replaces the small individual tube of freestanding water affixed to the bottom of the flower stem(s).

Thus, the present method provides hydration for all movements of the flowers from the point of cutting by the grower until the sale to a customer and, perhaps, during transportation by the customer to the ultimate location. That is, this method can be used during storage and transport from the grower to the distribution center, from the distribution center to the florist or retail store, and/or from the florist or retail store to the customer.

The method of the present disclosure can be used in conjunction with a shipping container that has a separate absorbent pad 10 positioned on one or more of the walls of the container (i.e., not wrapped around stems 30) during transport of the cut flowers from the grower to a retail center. The separate absorbent pad provides hydration and moisture that prevents drying of the cut flowers during storage and transport. The absorbent pad can also contain one or more active agent, such as those described above, that prolongs the life of the cut flowers, inhibits microbial growth, and improves their physical appearance and sensory characteristics as compared with cut flowers transported by conventional methods.

The method of the present disclosure, by providing hydration to cut flowers during packing, storage, and transport, allows the flower grower and processor (at the start of the supply chain) to exert control over the lifespan and appearance of the cut flowers long after the shipping containers have left the grower's docks and are in transit. This represents a significant benefit to the flower grower and processor.

As used in this application, a “shipping container” is any enclosed, controlled environment for packaging cut flowers that prevents passage of normal atmospheric air to the cut flowers therein, yet provides access to the cut flowers so that flowers can be placed in, or taken therefrom. Examples of a shipping container include, but are not limited to, a cardboard box, a metal or plastic container having a cover, a sealable bag, and a closeable cooler, including those containers that briefly store the cut flowers (but are not used in transport). The shipping container is often not airtight (i.e., it remains permeable to ambient air and humidity), even after the cut flowers are placed inside and the container is closed and sealed for shipping. However, the method and absorbent pad of the present disclosure can be used in shipping containers that are airtight. A typical shipping container for flowers is a cardboard box having dimensions that are about 4 feet (4′) (121.9 cm) to about five feet (5′) (152.4 cm) in length by about one foot (1′) (30.5 cm) in width by about 4 inches (4″) (10.2 cm) to ten inches (10″) (25.4 cm) in height. A preferred size of a shipping container is a cardboard box that is 41″ (104.1 cm) in length×10″ (25.4 cm) in width×8″ (20.3 cm). Approximately 100 to 200 cut roses are typically placed in a shipping box of these dimensions.

The method of the present disclosure is operable below 32° F. (0° C.). However, cut flowers are generally not transported below the freezing temperature of water because of unfavorable effects on flower appearance. As noted above, cut flowers are often shipped in chilled temperatures between 34° F.-40° F. (1.1° C.-4.4° C.) to decrease respiration of the flowers, and preserve their lifespan, physical appearance, and sensory attractiveness (e.g., floral “smell”).

Although the method of the present disclosure focuses on and is particularly effective for hydrating cut flowers, the method and absorbent pad can be used to hydrate, feed, and extend the shelf life of any flowering plant species, including but not limited to flowering vegetable plants, such as asparagus and cabbage. In the instance of asparagus, it may be advantageous to place absorbent pad 10 at the bottom of the shipping container.

As used in this application, the word “about” for dimensions, weights, and other measures means a range that is ±10% of the stated value, more preferably ±5% of the stated value, and most preferably ±1% of the stated value, including all subranges therebetween.

It should be understood that the foregoing description is only illustrative of the present disclosure. Various alternatives and modifications can be devised by those skilled in the art without departing from the present disclosure. Accordingly, the present disclosure is intended to embrace all such alternatives, modifications, and variances that fall within the scope of the disclosure.

What is claimed is:

1. An absorbent pad for hydrating a cut flower comprising:
a top layer;
a bottom layer of a liquid-impermeable material;
an absorbent body positioned between the top layer and the bottom layer, the absorbent body being made of an absorbent material in the form of one or more layers of tissue; and
a superabsorbent layer positioned between the bottom layer and a bottommost one of the one or more layers of tissue,
wherein the layers of tissue wick water and moisture vertically and horizontally through the absorbent pad thereby hydrating the cut flower when the absorbent pad is positioned to be in contact with a stem of the cut flower.

2. The absorbent pad of claim 1, further comprising an active agent in the absorbent body, wherein the absorbent pad releases the active agent upon contact with water.

3. The absorbent pad of claim 2, wherein the active agent inhibits the effects of ethylene on the cut flower, inhibits botrytis in the cut flower, or a combination of both.

4. The absorbent pad of claim 2, wherein the active agent is an antimicrobial agent selected from the group consisting of a carbon dioxide generation system, an oxygen scavenging system, a chlorine dioxide generation system, a sulfur dioxide generation system, an oxidizing agent, an ethylene inhibitor, an ethylene competitive agent, and any combination thereof.

5. The absorbent pad of claim 2, wherein the active agent is selected from the group consisting of vitamins, sugar, plant hormones, and any combination thereof.

6. The absorbent pad of claim 2, wherein the active agent includes a compound that is an ethylene competitive agent.

7. The absorbent pad of claim 6, wherein the ethylene competitive agent is 1-methylcyclopropene, salts thereof, or derivatives thereof.

8. The absorbent pad of claim 4, wherein the antimicrobial agent is about 2.0 weight % based on nominal absorbency of the absorbent pad.

9. The absorbent pad of claim 1, wherein the absorbent pad includes a laminate positioned between the top layer and the bottom layer.

10. The absorbent pad of claim 9, wherein the laminate is 3.0 grams per square inch in the absorbent body.

11. The absorbent pad of claim 9, wherein the laminate includes two or more plies of a cellulosic material.

12. The absorbent pad of claim 1, wherein the absorbency of the absorbent body is from about 250 grams to about 600 grams.

13. The absorbent pad of claim 1, wherein the bottom layer is a film having a thickness of about 0.65 mil.

14. The absorbent pad of claim 1, wherein the superabsorbent layer is a superabsorbent material that can absorb and contain water to be a water reservoir, and wherein the absorbent body pulls water from the water reservoir.

15. The absorbent pad of claim 13, wherein the one or more layers of tissue include at least three layers of tissue.

16. A system to hydrate a cut flower, the system comprising:
a container used for transport or storage of the cut flower;
an absorbent pad placed in the container, the absorbent pad including:
a top layer;
a bottom layer;
an absorbent body positioned between the top layer and the bottom layer, the absorbent body being made of an absorbent material in the form of one or more layers of tissue; and
a superabsorbent layer positioned between the bottom layer and a bottommost one of the one or more layers of tissue,
wherein the layers of tissue wick water and moisture vertically and horizontally through the absorbent pad thereby hydrating the cut flower when the absorbent pad is wrapped around a stem of the cut flower.

17. A method of hydrating a cut flower in a container, comprising:
providing one or more cut flowers;
providing an absorbent pad including:
a top layer;
a bottom layer;
an absorbent body positioned between the top layer and the bottom layer, the absorbent body being made of an absorbent material in the form of one or more layers of tissue; and
a superabsorbent layer positioned between the bottom layer and a bottommost one of the one or more layers of tissue,
securing the absorbent pad around stems of the cut flowers; and
adding water to the absorbent pad.

18. The method of claim 17, further comprising an active agent in the absorbent body, wherein the active agent releases upon contact with water.

19. The method of claim 17, further comprising placing the cut flowers in the container for transporting the cut flowers.

20. The method of claim 17, wherein the absorbent pad is elastically secured to the cut flowers.
